(19) United States
(12) Patent Application Publication
(10) Pub. No.: US 2021/0209447 A1
(43) Pub. Date: Jul. 8, 2021

(54) INFORMATION PROCESSING APPARATUS, CONTROL METHOD, AND PROGRAM

(71) Applicant: NEC Corporation, Minato-ku, Tokyo (JP)

(72) Inventors: Yuzuru OKAJIMA, Tokyo (JP); Kunihiko SADAMASA, Tokyo (JP)

(73) Assignee: NEC Corporation, Minato-ku, Tokyo (JP)

(21) Appl. No.: 17/058,809

(22) PCT Filed: May 31, 2018
(86) PCT No.: PCT/JP2018/020953

§ 371 Date: Nov. 25, 2020

(51) Int. Cl. G06N 3/04; G06N 5/00; G06N 5/02

(52) U.S. Cl. CPC G06N 3/0427; G06N 5/025; G06N 5/003

(57) ABSTRACT

An information processing apparatus (2000) acquires input data (10). The information processing apparatus (2000) extracts a prediction rule (50) used for prediction related to the input data (10) from a usage rule set (60) by using a neural network (30). The usage rule set (60) includes a plurality of candidates for the prediction rule (50) used for prediction related to the input data (10). The prediction rule (50) is information in which condition data (52) representing a basis for prediction and conclusion data (54) representing a prediction related to the input data (10) are associated with each other. The prediction rule (50) used for prediction related to the input data (10) indicates the condition data (52) indicating a condition satisfied by the input data (10). The information processing apparatus (2000) outputs a prediction result (20), based on the conclusion data (54) indicating the extracted prediction rule (50).

### TECHNICAL FIELD

The present invention relates to prediction using a neural network.

### BACKGROUND ART

In a machine learning field, a model on a rule base acquired by combining a plurality of simple conditions has an advantage of easy interpretation. A typical example of the model is a decision tree. Each node of a decision tree represents a simple condition, and following the decision tree from a root to a leaf corresponds to prediction by using a determination rule acquired by combining a plurality of simple conditions.

On the other hand, machine learning using a complicated model such as a neural network indicates high prediction performance and receives attention. Particularly, the machine learning indicates higher prediction performance than that of a model on a rule base such as a decision tree in data having a complicated expression such as an image and text.

A shortcoming of a complicated model such as a neural network is that an inference process is difficult to interpret since an internal structure of the model is complicated. In other words, it is difficult for human to understand a basis for prediction of the model. For example, a case where binary classification that outputs YES or NO is performed is considered. In a neural network, whether YES or NO can be output with high accuracy. However, a process of determining YES and NO is complicated, and it is difficult for human to understand a basis of the determination.

In the technical field described above, NPL 1 discloses a technique of causing a neural network to adjust a parameter of a graphical model instead of directly using the neural network for prediction. By using the technique, instead of the neural network, the graphical model that is a simpler model than the neural network can be presented to human.

NPL 2 discloses a technique of approximating a structure of a trained neural network by a decision tree. By using the technique, with a simple neural network that can be approximated by a decision tree, a decision tree that performs an operation imitating the neural network can be presented to human.

### CITATION LIST

### Non Patent Literature

[NPL 1] Maruan Al-Shedivat, Avinava Dubey, and Eric P. Xing, “Contextual Explanation Networks”, [online], May 29, 2017, arXiv, [searched on Mar. 1, 2018], the Internet, <URL: https://arxiv.org/abs/1705.10301>

[NPL 2] Jan Ruben Zilke, Eneldo Loza Mencia, and frederik Janssen, “DeepRED—Rule Extraction from Deep Neural Networks”, Discovery Science, Springer, Cham, 2017, vol 9956

### SUMMARY OF INVENTION

### Technical Problem

In the prior art, ease of interpretation and a degree of prediction accuracy are not compatible. For example, the graphical model disclosed in NPL 1 cannot be broken down into a combination of simple conditions, and thus has a problem of difficult interpretation. Further, in the technique described in NPL 2, a model of a neural network that can be used is limited to a simple model that can be approximated by a decision tree, and thus prediction performance decreases.

The invention of the present application has been made in view of the above-described problem, and an object thereof is to achieve prediction that allows a basis for the prediction to be easily interpreted and has high accuracy.

### Solution to Problem

An information processing apparatus according to the present invention includes 1) an acquisition unit that acquires input data, and 2) an extraction unit that extracts, from a usage rule set including a plurality of prediction rules, a prediction rule associated with the input data by using a neural network. The prediction rule associates, with each other, condition data indicating a condition being a basis for prediction, and conclusion data representing a prediction based on the condition indicated by the condition data. The information processing apparatus further includes 3) an output unit that performs an output based on the extracted prediction rule. The condition data of the prediction rule associated with the input data indicate a condition satisfied by the acquired input data.

A control method according to the present invention is executed by a computer. The control method includes 1) an acquisition step of acquiring input data, and 2) an extraction step of extracting, from a usage rule set including a plurality of prediction rules, the prediction rule associated with the input data by using a neural network. The prediction rule associates, with each other, condition data indicating a condition being a basis for prediction, and conclusion data representing a prediction based on the condition indicated by the condition data. The control method further includes 3) an output step of performing an output based on the extracted prediction rule. The condition data of the prediction rule associated with the input data indicate a condition satisfied by the acquired input data.

A program according to the present invention causes a computer to execute each step included in the control method according to the present invention.

### Advantageous Effects of Invention

The present invention achieves prediction that allows a basis for the prediction to be easily interpreted and has high accuracy.

### BRIEF DESCRIPTION OF DRAWINGS

The above-described object, the other objects, features, and advantages will become more apparent from suitable example embodiments described below and the following accompanying drawings.

FIG. 1 is a diagram schematically illustrating processing performed by an information processing apparatus according to the present example embodiment.

FIG. 2 is a diagram illustrating one example of a decision tree and a prediction rule associated with the decision tree.

FIG. 3 is a diagram illustrating one example of a graphical model and a prediction equation associated with the graphical model.

FIG. 4 is a diagram illustrating a functional configuration of an information processing apparatus according to an example embodiment 1.

FIG. 5 is a diagram illustrating a computer for achieving the information processing apparatus.

FIG. 6 is a flowchart illustrating a flow of processing performed by the information processing apparatus according to the example embodiment 1.

FIG. 7 is a diagram illustrating a configuration of a neural network.

FIG. 8 is a diagram illustrating a specific configuration of the neural network.

FIG. 9 is a block diagram illustrating a functional configuration of an information processing apparatus according to an example embodiment 2.

FIG. 10 is a block diagram illustrating a functional configuration of an information processing apparatus according to an example embodiment 3.

FIG. 11 is a diagram illustrating a technique of simultaneously performing optimization of a usage rule set and optimization of a neural network.

### EXAMPLE EMBODIMENT

Hereinafter, example embodiments of the present invention will be described with reference to the drawings. Note that, in all of the drawings, the same components have the same reference numerals, and description thereof will be appropriately omitted. Further, in each block diagram, each block represents a configuration of a functional unit instead of a configuration of a hardware unit unless otherwise described.

### Example Embodiment 1

### <Outline>

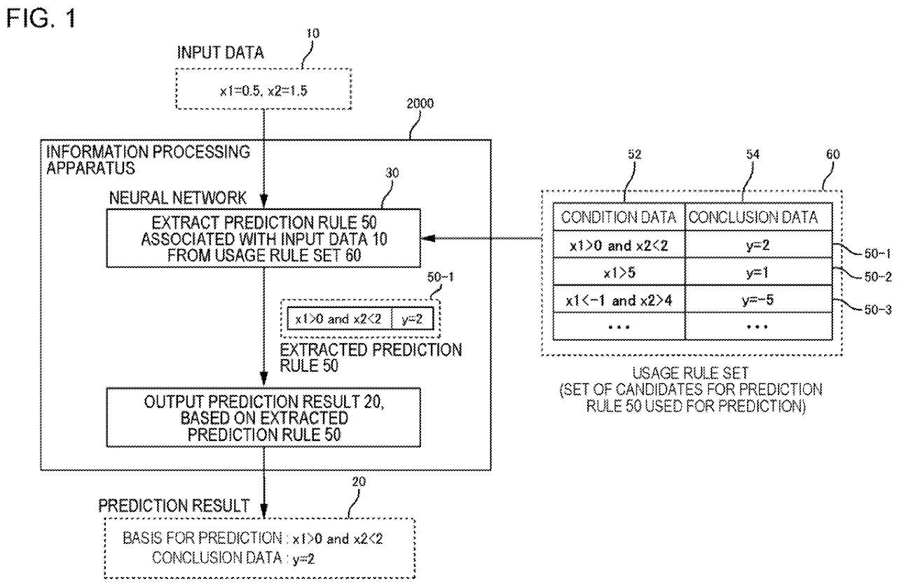

FIG. 1 is a diagram schematically illustrating processing performed by an information processing apparatus according to the present example embodiment. An information processing apparatus 2000 outputs a prediction related to input data. In FIG. 1, data to be input is input data 10, and data representing a result of prediction is a prediction result 20. Examples of processing of making a prediction about an input include processing (classification problem) of predicting a class (for example, human, dog, car, or the like) of an object included in input image data. In this case, the input image data is the input data 10. Further, the prediction result 20 indicates a predicted class and a basis for the prediction.

When the information processing apparatus 2000 acquires the input data 10, the information processing apparatus 2000 extracts a prediction rule 50 used for prediction related to the input data 10, from a usage rule set 60 by using a neural network (NN) 30. The usage rule set 60 includes a plurality of candidates for the prediction rule 50 used for prediction related to the input data 10. The prediction rule 50 is information in which condition data 52 representing a basis for prediction and conclusion data 54 representing a prediction related to the input data 10 are associated with each other. It can be said that the condition data 52 and the conclusion data 54 associated with each other by the prediction rule 50 have a relationship between a conditional clause and a conclusion clause. Extracting the prediction rule 50 from the usage rule set 60 corresponds to determining a prediction (conclusion data 54) related to the input data 10 and a basis (condition data 52) for the prediction. Note that the prediction rule 50 used for prediction related to the input data 10 indicates the condition data 52 indicating a condition satisfied by the input data 10.

The information processing apparatus 2000 outputs the prediction result 20, based on the conclusion data 54 indicated by the extracted prediction rule 50. For example, the prediction result 20 is a display screen, a file, and the like indicating a content of the prediction rule 50.

For example, it is assumed that two-dimensional data of “x1=0.5, x2=1.5” are input as the input data 10. In this case, for example, the neural network 30 extracts a prediction rule 50-1 of “condition data: x1>0 and x2<2, prediction data: y=2” from the usage rule set 60. The prediction rule 50-1 is a prediction rule that makes a prediction of “y=2” on the basis of a fact that the input data 10 satisfy a condition of “x1>0 and x2<2”. Herein, as in each of the prediction rules 50 illustrated in FIG. 1, a meaning of a condition represented by a combination of an element name, a threshold value, and an inequality sign can be easily understood by human (that is, interpreting is easy).

Note that, as described below, an element (x1 and x2 described above) conditioned by the condition data 52 may be a feature extracted from the input data 10 (for example, a feature value extracted from image data) instead of a value directly indicated by the input data 10. In this case, the neural network 30 receives the input data 10 as an input and extracts a feature from the input data 10, or receives a feature extracted from the input data 10 as an input, and then performs processing on the extracted feature and outputs the prediction rule 50. Details of the feature extraction will be described below. Further, in this case, “the input data 10 satisfy a condition indicated by the condition data 52” refers to “a feature extracted from the input data 10 satisfies a condition indicated by the condition data 52”.

### Advantageous Effect

In order to clarify an advantageous effect achieved by the information processing apparatus 2000 according to the present embodiment, a decision tree and a graphical model that are the prior art in the present technical field will be described.

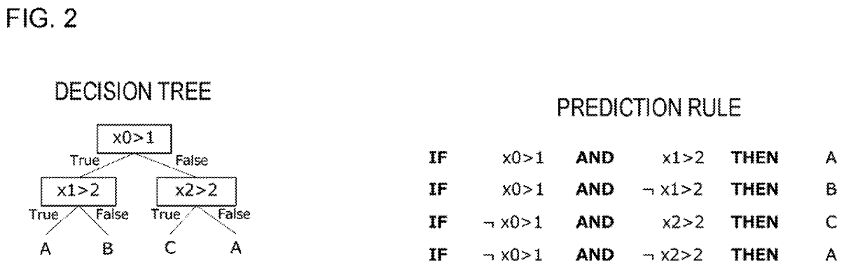

FIG. 2 is a diagram illustrating one example of a decision tree and a prediction rule associated with the decision tree. Each internal node of a decision tree represents a condition, and includes two child nodes associated with true and false of the condition. When data is input, a search starts from a root node in the decision tree. When the condition is true for the input data, a node subordinate to the child node associated with true is further searched, and when the condition is false, a node subordinate to the child node associated with false is further searched. The search is repeated, and when a leaf node is reached, a prediction value of the leaf node is output as a prediction result.

It can be interpreted that each path from a root of a decision tree to a leaf node is a prediction rule formed of a condition unit and a conclusion clause. The condition unit is represented by a complex condition in which conditions included in inner nodes passing through a path from a root node to a leaf node are coupled with a negation and an AND. The example in FIG. 2 illustrates four prediction rules associated with four leaf nodes of the decision tree.

It is easy for human to interpret a prediction rule associated with a decision tree. The reason is that the prediction rule can be regarded as a combination of simple conditions related to one element. Further, the reason is that true or false of each condition is not affected by another condition, and thus human can easily determine true or false of each condition. In the example in FIG. 2, whether “x0>1” holds true can be determined by checking only a value of an element x0, and another element x1 does not need to be considered. Further, whether the condition holds true is either true or false and thus has no ambiguity.

Further, when each of conditions is formed of one element and one threshold value, a meaning of the threshold value itself is clear, and a meaning of a complex condition acquired by combining the conditions is also clear.

For example, it is assumed that observation data represent temperature and humidity in prediction of a mechanical failure. At this time, it is assumed that a prediction rule that a “machine is in failure when a condition of “temperature>45 and humidity>70” holds true” is acquired. According to the prediction rule, intuitively clear knowledge that a “failure occurs when temperature becomes higher than 45 degrees and humidity exceeds 70%”, which is useful to a user.

In contrast, when a prediction rule is generated by a condition of a value acquired by combining a plurality of elements, interpretation of the rule is difficult. For example, it is assumed that there is a prediction rule that a “machine is in failure when a condition of “3.5*temperature+1.9*humidity>23” holds true”. In this case, the threshold value of 23 is not a value directly representing the temperature and the humidity, and thus it is difficult to intuitively understand a meaning of the threshold value. In other words, a person cannot easily recognize what kind of value of temperature and humidity causes a possibility that a machine is in failure only by looking at the prediction rule.

While a decision tree is easy to interpret, a decision tree has a shortcoming of relatively low prediction performance. In order to eliminate the shortcoming, a decision tree having prediction performance improved by using a complicated condition using many elements as a node is also proposed. However, when a decision tree is made complicated, prediction performance improves, but an advantage of easy interpretation is lost.

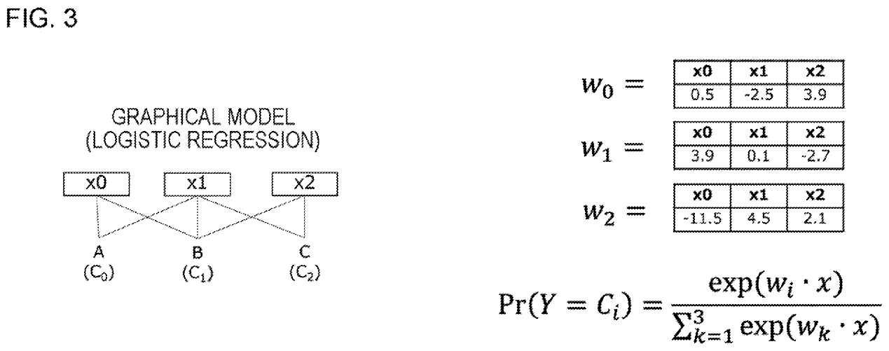

Next, a graphical model will be described. FIG. 3 is a diagram illustrating one example of a graphical model and a prediction equation associated with the graphical model. The graphical model illustrated in FIG. 3 is one of the simplest graphical models referred to as logistic regression. w0, w1, and w2 are each a weight vector for predicting classes C0, C1, and C2.

In such a graphical model, each element each takes a continuous value, and is further multiplied by a weight of the continuous value, and a sum of the obtained values determines a prediction result. Therefore, it is difficult for human to interpret a prediction rule (prediction equation) associated with the graphical model. For example, importance of each element is determined by the size relative to a weight of another element, and thus importance of an individual element cannot be independently determined.

In terms of the example of the failure prediction described above, the graphical model can indicate only a prediction equation acquired by complicatedly combining the values of the temperature and the humidity, and a prediction equation that can be intuitively understood in such a way that a “failure occurs when temperature becomes higher than 45 degrees and humidity exceeds 70%” cannot be generated.

As described above, 1) a decision tree has a problem that prediction performance is low while interpretation of a prediction rule is easy, and 2) a graphical model has a problem that interpretation of a prediction rule is difficult while prediction performance is high.

In this regard, the information processing apparatus 2000 according to the present example embodiment acquires the prediction rule 50 including a basis (condition data 52) for prediction and a result (conclusion data 54) of the prediction based on the basis by using the neural network 30 in response to an input of the input data 10, and thus makes a prediction related to the input data 10. In other words, a prediction made by the information processing apparatus 2000 corresponds to prediction according to a prediction rule formed of a conditional clause and a conclusion clause. Thus, the information processing apparatus 2000 can provide, to a user, a prediction rule easy for human to interpret. Particularly, when a conditional clause is formed of a combination of simple conditions (for example, a threshold value condition related to one element), interpretation ease for human increases.

Furthermore, the information processing apparatus 2000 uses the neural network 30 for extraction of the prediction rule 50. In general, a neural network has higher prediction accuracy than that of a decision tree. Thus, by using the information processing apparatus 2000, a prediction rule easy to understand like a decision tree can be provided to a user, and a prediction with high accuracy can also be made.

Herein, one of important advantages in the information processing apparatus 2000 is “no limitation on complication of a model of the neural network 30”. In the technique (see NPL 2) of simplifying and approximating a neural network by a decision tree, there is a limitation that a neural network of a simple model that can be approximated by a decision tree can only be used. Thus, it is difficult to increase prediction accuracy.

In this regard, instead of causing a neural network to output the prediction result 20 itself, the information processing apparatus 2000 causes the neural network 30 to extract the prediction rule 50 used for determining the prediction result 20. Thus, since a neural network itself does not represent a prediction rule, a neural network to be used does not need to be able to be approximated to a decision tree. For this reason, a neural network having any complication can be used.

Herein, the prediction rule 50 extracted by using the neural network 30 is one of the plurality of prediction rules 50 included in the usage rule set 60. The usage rule set 60 is prepared in advance. Selecting the prediction rule 50 to be used for prediction from among the plurality of prediction rules 50 prepared in advance has an advantage that a user is easily convinced of a basis for the prediction.

For example, it is also conceivable that the neural network 30 is configured in such a way as to generate any prediction rule 50 instead of the neural network 30 extracting the prediction rule 50 from the usage rule set 60. However, when the neural network 30 is configured to be able to generate any prediction rule 50, a situation where a user is less likely to be convinced of a basis for prediction is conceivable, such as a situation where the prediction rules 50 indicating greatly different bases for the prediction are generated for pieces of the input data 10 similar to each other.

In this regard, the information processing apparatus 2000 according to the present example embodiment uses the prediction rule 50 within a predetermined range, which is the prediction rule 50 included in the usage rule set 60, and can thus prevent the situation where a user is less likely to be convinced of a basis for prediction.

Note that the above-described description with reference to FIG. 1 is exemplification for facilitating understanding of the information processing apparatus 2000, and does not limit a function of the information processing apparatus 2000. Hereinafter, the information processing apparatus 2000 according to the present example embodiment will be described in more detail.

### <Example of Functional Configuration of Information Processing Apparatus 2000>

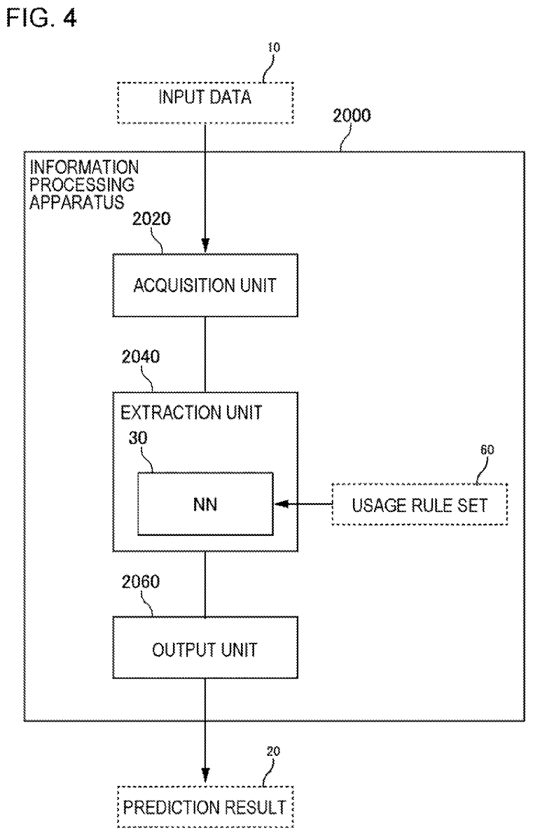

FIG. 4 is a diagram illustrating a functional configuration of the information processing apparatus 2000 according to an example embodiment 1. The information processing apparatus 2000 includes an acquisition unit 2020, an extraction unit 2040, and an output unit 2060. The acquisition unit 2020 acquires the input data 10. The extraction unit 2040 extracts the prediction rule 50 associated with the input data 10 from the usage rule set 60 by using the neural network 30. The output unit 2060 outputs the prediction result 20, based on the extracted prediction rule 50.

### <Hardware Configuration of Information Processing Apparatus 2000>

Each functional component unit of the information processing apparatus 2000 may be achieved by hardware (for example, a hard-wired electronic circuit and the like) that achieves each functional component unit, and may be achieved by a combination (for example, a combination of an electronic circuit and a program that controls the electronic circuit, and the like) of hardware and software. Hereinafter, a case where each functional component unit of the information processing apparatus 2000 is achieved by the combination of hardware and software will be further described.

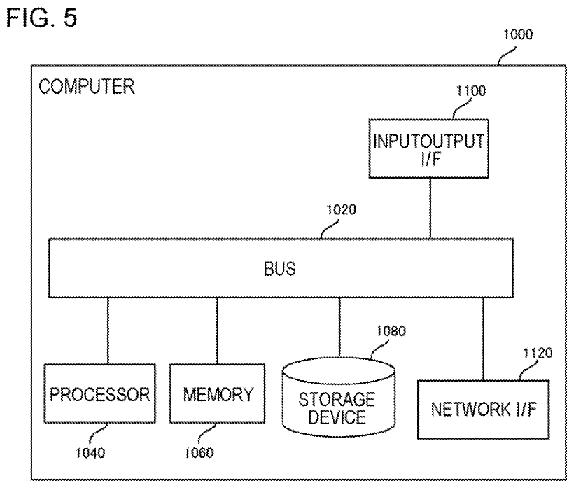

FIG. 5 is a diagram illustrating a computer 1000 for achieving the information processing apparatus 2000. The computer 1000 is any computer. For example, the computer 1000 is a personal computer (PC), a server machine, or the like. The computer 1000 may be a dedicated computer designed for achieving the information processing apparatus 2000, and may be a general-purpose computer.

The computer 1000 includes a bus 1020, a processor 1040, a memory 1060, a storage device 1080, an input/output interface 1100, and a network interface 1120. The bus 1020 is a data transmission path for allowing the processor 1040, the memory 1060, the storage device 1080, the input/output interface 1100, and the network interface 1120 to transmit and receive data with one another. However, a method of connecting the processor 1040 and the like to each other is not limited to a bus connection.

The processor 1040 is various types of processors such as a central processing unit (CPU), a graphics processing unit (GPU), and a field-programmable gate array (FPGA). The memory 1060 is a main storage achieved by using a random access memory (RAM) and the like. The storage device 1080 is an auxiliary storage achieved by using a hard disk, a solid state drive (SSD), a memory card, a read only memory (ROM), or the like.

The input/output interface 1100 is an interface for connecting the computer 1000 and an input/output device. For example, an input apparatus such as a keyboard and an output apparatus such as a display apparatus are connected to the input/output interface 1100. The network interface 1120 is an interface for connecting the computer 1000 to a communication network. The communication network is, for example, a local area network (LAN) and a wide area network (WAN). A method of connection to the communication network by the network interface 1120 may be a wireless connection or a wired connection.

The storage device 1080 stores a program module that achieves each functional component unit of the information processing apparatus 2000. The processor 1040 achieves a function associated with each program module by reading each of the program modules to the memory 1060 and executing the program module.

The storage device 1080 may further store the usage rule set 60. However, the usage rule set 60 only has to be information that can be acquired from the computer 1000, and is not necessarily stored in the storage device 1080. For example, the usage rule set 60 can be stored in a database server connected to the computer 1000 via the network interface 1120.

### <Flow of Processing>

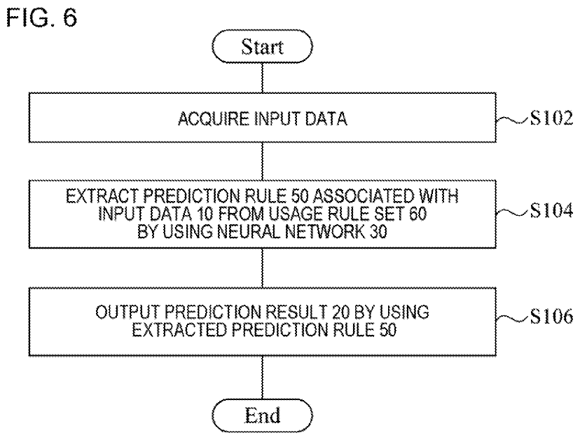

FIG. 6 is a flowchart illustrating a flow of processing performed by the information processing apparatus 2000 according to the example embodiment 1. The acquisition unit 2020 acquires the input data 10 (S102). The extraction unit 2040 extracts the prediction rule 50 associated with the input data 10 from the usage rule set 60 by using the neural network 30 (S104). The output unit 2060 outputs the prediction result 20, based on the prediction rule 50 (S106).

### <Acquisition of Input Data 10: S102>

The acquisition unit 2020 acquires the input data 10 (S102). The input data 10 is data needed for making a prediction that is a purpose. For example, as described above, in the processing of predicting a class of an object included in image data, the image data can be used as the input data 10. However, the input data 10 is not limited to image data, and any data such as text data can be set as the input data 10.

Note that one or more features (hereinafter, feature vectors) acquired as a result of performing preprocessing of performing feature extraction on image data and text data may be set as the input data 10. In this case, the neural network 30 described below does not need to have a function of performing feature extraction.

The input data 10 is formed of one or more pieces of various types of data (such as numerical data, character data, or character-string data). When the input data 10 is formed of two or more pieces of data, the input data 10 is represented in a vector form, for example. For example, data in a form of (0.5, 1.5) is acquired as the input data 10.

Any method can be used as a method of the acquisition unit 2020 acquiring the input data 10. For example, the acquisition unit 2020 acquires the input data 10 from a storage apparatus that stores the input data 10. The storage apparatus that stores the input data 10 may be provided inside the information processing apparatus 2000, and may be provided outside. In addition, for example, the information processing apparatus 2000 acquires the input data 10 input by an input operation by a user. In addition, for example, the acquisition unit 2020 acquires the input data 10 by receiving the input data 10 transmitted by another apparatus.

### <Extraction of Prediction Rule 50: S104>

The extraction unit 2040 extracts the prediction rule 50 from the usage rule set 60 by using the neural network 30. For example, the neural network 30 is configured in such a way as to extract the prediction rule 50 from the usage rule set 60 in response to an input of the input data 10, and output the extracted prediction rule 50. In addition, for example, the neural network 30 may output a vector indicating a degree that each of the prediction rules 50 included in the usage rule set 60 should be extracted. Hereinafter, a configuration of the neural network 30 will be described with a specific example.

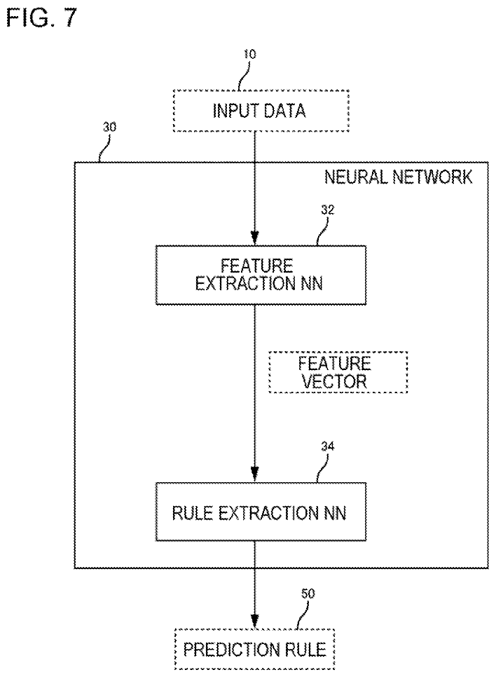

FIG. 7 is a diagram illustrating the configuration of the neural network 30. In FIG. 7, the neural network 30 includes a feature extraction network 32 and a rule extraction network 34. Note that, as described above, when a feature vector is input as the input data 10, the neural network 30 may not include the feature extraction network 32.

The feature extraction network 32 is a neural network that generates a feature vector by extracting a feature from the input data 10. Each output node of the feature extraction network 32 outputs a value of each element constituting a feature vector. For example, a feature extraction layer of a convolutional neural network can be used as the feature extraction network 32. However, a model of the feature extraction network 32 is not limited to a convolutional neural network, and various existing models (for example, a multilayer perceptron, a recurrent neural network, and the like) can be used.

The feature extraction network 32 is caused to learn in advance in such a way as to be able to extract a feature from the input data 10. Note that an existing technique can be used as a technique of causing a neural network to learn in such a way as to extract a feature from data.

The rule extraction network 34 extracts the prediction rule 50 from the usage rule set 60 by using the feature vector output from the feature extraction network 32. Each of a plurality of output nodes of the rule extraction network 34 is associated with each of the prediction rules 50 included in the usage rule set 60. For example, the rule extraction network 34 is caused to learn in advance in such a way as to output 1 from an output node associated with the prediction rule 50 (i.e., the prediction rule 50 that should be extracted) associated with the input data 10, and output 0 from the other output node, in response to an input of a feature vector extracted from the input data 10. Thus, the extraction unit 2040 inputs the input data 10 to the neural network 30, and extracts the prediction rule 50 associated with the output node from which 1 is output in the rule extraction network 34.

In addition, for example, the rule extraction network 34 is caused to learn in advance in such a way as to output, from each output node, a degree (for example, an occurrence probability) that each of the prediction rules 50 should be extracted, in response to an input of a feature vector extracted from the input data 10. The extraction unit 2040 extracts the prediction rule 50, based on a value output for each of the prediction rules 50 from the rule extraction network 34. For example, when the rule extraction network 34 outputs an occurrence probability of each of the prediction rules 50, the extraction unit 2040 extracts the prediction rule 50 by sampling one prediction rule 50 from the usage rule set 60 according to a probability distribution represented by each output occurrence probability.

Note that a learning method of the rule extraction network 34 will be described below.

Similarly to a model of the feature extraction network 32, various existing models of a neural network can also be used for a model of the rule extraction network 34. Herein, models of the feature extraction network 32 and the rule extraction network 34 may be identical to each other and may be different from each other.

A configuration of the neural network 30 is not limited to the above-described configuration including the feature extraction network 32 and the rule extraction network 34. For example, the neural network 30 may be configured as one neural network having both functions of the feature extraction network 32 and the rule extraction network 34.

In addition, for example, a neural network may not be used for processing of extracting feature data from the input data 10. In this case, the rule extraction network 34 is used as the neural network 30. The extraction unit 2040 generates the prediction rule 50 by performing the processing of extracting feature data from the input data 10, and inputting the extracted feature data as a result to the rule extraction network 34. Note that an existing technique can be used as a technique of extracting a feature from various types of data such as image data and text data by a means other than a neural network.

Further, the neural network 30 may perform extraction of the prediction rule 50, based on the input data 10 itself instead of feature data of the input data 10. The neural network 30 does not include the feature extraction network 32 and inputs the input data 10 to the rule extraction network 34.

### «Detailed Specific Example of Neural Network 30»

Herein, a configuration of the neural network 30 will be described with a specific example. However, the configuration described below is one example, and the configuration of the neural network 30 can adopt various configurations.

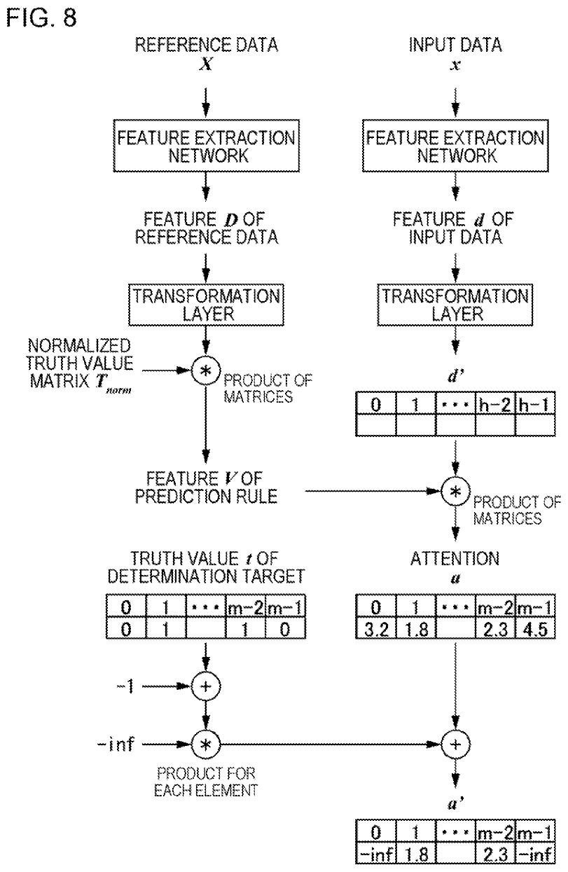

FIG. 8 is a diagram illustrating a specific configuration of the neural network 30. In this example, a plurality of pieces of input data (hereinafter, reference data) having a known correct answer (correct prediction result) are prepared other than the input data 10. Then, by using the reference data and correct answer data associated with the reference data, a matrix (hereinafter, a feature matrix of the usage rule set 60) representing a feature related to each of the prediction rules 50 included in the usage rule set 60 is prepared. The neural network 30 outputs a degree that each of the prediction rules 50 should be extracted by using a feature vector extracted from the input data 10 and the feature matrix of the usage rule set 60.

First, a method of generating a feature matrix of the usage rule set 60 will be described. First, a matrix X (reference data is a vector) in which the plurality of pieces of reference data are coupled is input to a feature extraction network, and thus a matrix D in which feature vectors of each of pieces of the reference data are coupled is acquired. Herein, it is assumed that a size of the feature vector is h, and the number of the pieces of the reference data is m. Thus, the matrix D is a matrix of the size (m, h). Note that the feature extraction network is similar to the feature extraction network 32 described above.

Next, the matrix D is transformed by using any transformation layer (for example, a layer that performs linear transformation), and a feature matrix V of the usage rule set 60 is acquired by calculating a matrix product for a matrix acquired by the transformation and a normalized truth value matrix Tₙₒᵣₘ. Note that the transformation layer may not be provided.

The normalized truth value matrix Tₙₒᵣₘ is acquired by normalizing a truth value matrix T in such a way that a total of each row is 1. The truth value matrix T indicates a truth value that represents whether each of the plurality of pieces of reference data satisfies the condition data 52 of each of the prediction rules 50. The truth value matrix T is a matrix of the size (m, n), and each element takes a value of either 1 or 0. A value in j row and i column of the truth value matrix T is 1 when a feature vector fi of i-th reference data satisfies j-th prediction rule rj, and is 0 in other cases.

The feature matrix V is the matrix of the size (m, h). An i-th row represents a feature vector of the prediction rule ri. From the calculation described above, the feature vector of the prediction rule ri is an average of transformed feature vectors of reference data whose feature vector satisfies the prediction rule ri.

The input data 10 is transformed to a feature vector d by being input to the feature extraction network 32. Then, the feature vector d is input to any transformation layer, and a vector d′ is acquired. Note that the transformation layer may not be provided.

Furthermore, an attention a is acquired as a matrix product (d′V) of the vector d′ acquired from the input data 10 and the feature matrix V of the prediction rule 50. The attention a is a vector of the size m, and an i-th element represents an appropriate degree (degree of appropriateness of being used for prediction related to the input data 10) of the prediction rule ri with respect to the input data 10.

Furthermore, the attention a is transformed by using a truth value (that is, whether the input data 10 satisfy the condition data 52 of each of the prediction rules 50) related to each of the prediction rules 50 of the input data 10. The processing is processing for preventing the prediction rule 50 in which the input data 10 do not satisfy the condition data 52 from being extracted by the extraction unit 2040.

Specifically, after −1 is added to each element of a truth value vector t representing a truth value related to each of the prediction rules 50 of the input data 10, each element is multiplied by −∞. The truth value vector indicates a truth value for the prediction rule ri to the i-th element. In other words, a value of the i-th element is 1 when the input data 10 satisfy the condition data 52 of the prediction rule ri, and is 0 when the input data 10 do not satisfy the condition data 52 of the prediction rule ri.

As a result of the above-described processing, the vector t is transformed to a vector that indicates 0 to an element associated with the prediction rule 50 in which the input data 10 satisfy the condition data 52, and indicates −∞ to an element associated with the prediction rule 50 in which the input data 10 do not satisfy the condition data 52. Then, an attention a′ is acquired by adding the transformed vector t to the attention a. In the attention a′, the element associated with the prediction rule 50 in which the input data 10 do not satisfy the condition data 52 is −∞, and the other element is the same as the corresponding element of the attention a.

The neural network 30 outputs a vector based on the attention a′. For example, the neural network 30 outputs a vector acquired by transforming the attention a′ by an arg max layer (a layer that performs transformation by an arg max function). In this case, the neural network 30 outputs 1 only from an output node associated with an element having a maximum value in the attention a′, and outputs 0 from the other output node. The extraction unit 2040 extracts the prediction rule 50 associated with the output node from which 1 is output.

Herein, as described below, a priority degree (referred to as a first priority degree) may be given to each of the prediction rules 50 in advance. In this case, for example, the neural network 30 outputs a vector acquired by transforming the attention a′ by a softmax layer (a layer that performs transformation by a softmax function). Each element of the attention a′ is transformed to a probability based on the size of the element by the softmax layer. The extraction unit 2040 multiplies a vector output from the neural network 30 and a vector representing a priority degree of each of the prediction rules 50 given in advance, and transforms the vector as the multiplication result by the arg max layer. The extraction unit 2040 extracts the prediction rule 50 having a value of 1. In this way, the prediction rule 50 having a maximum product of a probability output from the neural network 30 and a priority degree is extracted. Thus, the most appropriate prediction rule 50 can be extracted in consideration of a priority degree of each of the prediction rules 50.

### <Output of Prediction Result 20: S106>

The output unit 2060 outputs the prediction result 20, based on the extracted prediction rule 50 (S106). For example, the output unit 2060 outputs, as the prediction result 20, a character string representing a content of the prediction rule 50. In addition, for example, the output unit 2060 may output, as the prediction result 20, information in which a content of the prediction rule 50 is graphically represented by using a graph, a drawing, and the like.

There are various output destinations of information representing the prediction rule 50. For example, the output unit 2060 displays information representing the extracted prediction rule 50 on a display apparatus. In addition, for example, the output unit 2060 may store the information representing the extracted prediction rule 50 in the storage apparatus. In addition, for example, when a user accesses the information processing apparatus 2000 from another terminal, the information processing apparatus 2000 may transmit the information representing the extracted prediction rule 50 to the another terminal.

### <Priority Degree of Prediction Rule 50>

The prediction rule 50 may be provided with a priority degree. As described above, the priority degree is referred to as the first priority degree. In this case, the extraction unit 2040 determines the prediction rule 50 to be extracted, based on an output result of the neural network 30 and the first priority degree provided to the prediction rule 50. For example, as described above, a vector indicating an occurrence probability of each of the prediction rules 50 is extracted from the neural network 30, and the extraction unit 2040 calculates a product of the vector and a vector indicating the first priority degree of each of the prediction rules 50. Then, the extraction unit 2040 extracts the prediction rule 50, based on the calculated vector. For example, as described above, the extraction unit 2040 extracts the prediction rule 50 having the above-described product at maximum. In addition, for example, the extraction unit 2040 may extract the prediction rule 50 by sampling the prediction rule 50 from the usage rule set 60 according to a probability distribution based on the above-described product calculated for each of the prediction rules 50.

### Example Embodiment 2

An information processing apparatus 2000 according to an example embodiment 2 further includes a function of generating a usage rule set 60. The information processing apparatus 2000 generates the usage rule set 60 by using a candidate rule set 70. The candidate rule set 70 includes a plurality of prediction rules 50. The number of the prediction rules 50 included in the candidate rule set 70 is greater than the number of the prediction rules 50 included in the usage rule set 60. In other words, the usage rule set 60 is a subset of the candidate rule set 70. The information processing apparatus 2000 according to the example embodiment 2 includes a function similar to that of the information processing apparatus 2000 according to the example embodiment 1 except for a point described below.

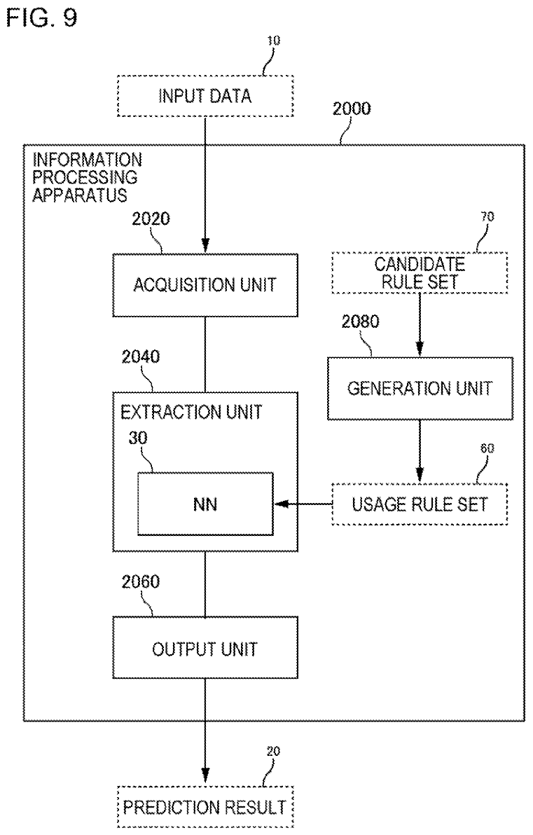

FIG. 9 is a block diagram illustrating a functional configuration of the information processing apparatus 2000 according to the example embodiment 2. The information processing apparatus 2000 according to the example embodiment 2 includes a generation unit 2080. The generation unit 2080 generates the usage rule set 60 by using the candidate rule set 70. Specifically, the generation unit 2080 extracts the plurality of prediction rules 50 from the candidate rule set 70, and generates the usage rule set 60 including the plurality of extracted prediction rules 50. A detailed method of extracting the prediction rule 50 from the candidate rule set 70 will be described below.

### <Action and Effect>

The information processing apparatus 2000 according to the present example embodiment generates the usage rule set 60 being a set of candidates for the prediction rule 50 extracted by the extraction unit 2040 as a partial set of a set (candidate rule set 70) of all of the prediction rules 50 being prepared. By automatically generating the usage rule set 60 in such a manner, a burden on a user of generating the usage rule set 60 can be reduced.

Further, by adopting a method of preparing a greater number of the prediction rules 50 than the number of the prediction rules 50 included in the usage rule set 60 and generating the usage rule set 60 with some of the prepared prediction rules 50, the prediction rule 50 unnecessary for prediction can be excluded from a candidate for the prediction rule 50 to be used by the information processing apparatus 2000. In this way, a prediction result can be described with only a small number of rules narrowed down from a large quantity of rules. In this way, a burden on a user of checking a rule used for prediction can be reduced. Further, when a size of a usage rule set is appropriately selected, overlearning can be prevented, and accuracy of prediction by the information processing apparatus 2000 can be improved.

### <Generation of Usage Rule Set 60>

Various methods can be adopted for a method of the generation unit 2080 generating the usage rule set 60. For example, the generation unit 2080 randomly samples a predetermined number of the prediction rules 50 from the candidate rule set 70, and generates the usage rule set 60 including the sampled prediction rule 50. Note that overlapping of the sampled prediction rules 50 may be permitted or may not be permitted. In the former, the number of the prediction rules 50 included in the usage rule set 60 is a predetermined number. On the other hand, in the latter, the number of the prediction rules 50 included in the usage rule set 60 is equal to or less than a predetermined number.

Herein, when sampling is performed while overlapping is permitted, a first priority degree according to the number of sampling times may be provided to the prediction rule 50. In other words, a first priority degree of the prediction rule 50 to be included in the usage rule set 60 is increased as the number of sampling times from the candidate rule set 70 is higher.

Further, a priority degree (hereinafter, a second priority degree) to be included in the usage rule set 60 may be provided to each of the prediction rules 50 included in the candidate rule set 70. In this case, the generation unit 2080 includes, in the usage rule set 60, the prediction rule 50 having a higher second priority degree at a higher probability. For example, when the above-described sampling is performed, the prediction rule 50 having a higher second priority degree is sampled at a higher probability. A probability of sampling each of the prediction rules 50 is calculated by, for example, dividing the second priority degree of each of the prediction rules 50 by a sum of the second priority degrees.

Any method of determining the second priority degree of the prediction rule 50 can be used. For example, the second priority degree of the prediction rule 50 generated by manpower is set higher than the second priority degree of the prediction rule 50 automatically generated by a computer. The reason is that a prediction rule generated by manpower conceivably has higher interpretability (easier for human to read) than a prediction rule automatically generated by a computer. In addition, for example, a higher priority degree may be set for the prediction rule 50 having a smaller number of conditions indicated by the condition data 52. The reason is that it can be said that interpretability is higher with a smaller number of conditions that are a basis for prediction.

### Example of Hardware Configuration>

A hardware configuration of a computer that achieves the information processing apparatus 2000 according to the example embodiment 2 is illustrated in, for example, FIG. 5 similarly to the example embodiment 1. However, a storage device 1080 of a computer 1000 that achieves the information processing apparatus 2000 according to the present example embodiment further stores a program module that achieves a function of the information processing apparatus 2000 according to the present example embodiment. Further, the candidate rule set 70 may be stored in the storage device 1080 of the computer 1000 that achieves the information processing apparatus 2000 according to the present example embodiment. However, the candidate rule set 70 may be stored in a storage apparatus (such as a database server connected to the computer 1000 via the network interface 1120) outside the information processing apparatus 2000.

### Example Embodiment 3

An information processing apparatus 2000 according to an example embodiment 3 further includes a function of conducting training of a neural network 30. In other words, the information processing apparatus 2000 according to the example embodiment 3 includes a function of updating an internal parameter of the neural network 30 in such a way as to reduce a prediction loss calculated based on an output of the neural network 30.

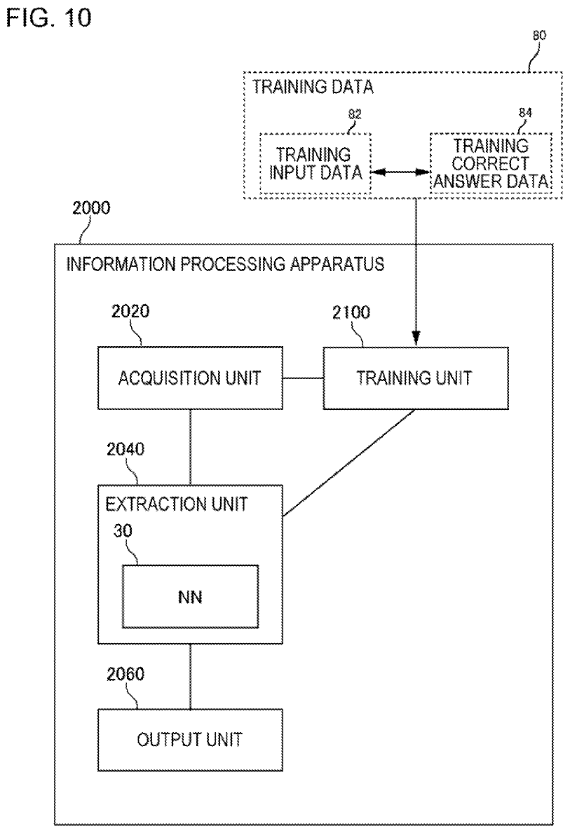

To achieve this, the information processing apparatus 2000 includes a training unit 2100. FIG. 10 is a block diagram illustrating a functional configuration of the information processing apparatus 2000 according to the example embodiment 3. The training unit 2100 conducts training of the neural network 30 by updating a parameter of the neural network 30 by using back propagation.

Hereinafter, a specific method of the training unit 2100 conducting training of the neural network 30 will be described.

The training unit 2100 acquires training data 80. The training data 80 are data in which training input data 82 and training correct answer data 84 are associated with each other. The training input data 82 are data of the similar type as input data 10. In other words, when the information processing apparatus 2000 treats image data as the input data 10, the training input data 82 are also image data. The training correct answer data 84 are data representing a correct answer for the training input data 82, and are data of the similar type as conclusion data 54. For example, it is assumed that the information processing apparatus 2000 predicts a class of an object included in the input data 10. In this case, for example, the training correct answer data 84 indicate a class of an object included in the training input data 82.

The training unit 2100 inputs the training input data 82 to an acquisition unit 2020, and acquires a prediction rule 50 extracted by an extraction unit 2040. Then, the training unit 2100 calculates a prediction loss for the conclusion data 54 included in the acquired prediction rule 50 and the training correct answer data 84. As the prediction loss, for example, a general prediction loss (such as a mean squared error and a cross entropy loss) used for training of a neural network can be used.

The training unit 2100 updates a parameter of the neural network 30 by performing back propagation processing in such a way as to reduce the calculated prediction loss. Herein, at least the training unit 2100 performs updating of a parameter of a rule extraction network 34 (conducts training of the rule extraction network 34). For a feature extraction network 32, training by the training unit 2100 may be conducted or may not be conducted. In the latter, training of the feature extraction network 32 is conducted in advance by a separate method. As described above, an existing technique can be used for training of the feature extraction network 32.

Note that an operation of the extraction unit 2040 may be different during training by the training unit 2100 (hereinafter, a training phase) and an actual operation of the information processing apparatus 2000 (hereinafter, a test phase). For example, in the detailed specific example of the neural network 30 described in the example embodiment 1, the extraction unit 2040 determines the prediction rule 50 to be extracted by using the arg max function. However, it is generally said that the arg max function is a function difficult for back propagation.

Thus, for example, the extraction unit 2040 in the training phase, i.e., the extraction unit 2040 used by the training unit 2100 is configured in such a way as to use a function that can achieve back propagation instead of the arg max function. For example, it is suitable to use a softmax function. The softmax function can be regarded as a continuous approximation of the arg max function. Thus, by using the softmax function, an output result close to that when the arg max function is used is acquired, and back propagation is also easy.

Note that it is particularly effective to use a softmax function with temperature. In this way, an output closer to an output of the arg max function can be acquired. Equation (1) below is an equation representing the softmax function with temperature.

$$\begin{matrix}[ Math . 1 ] & \\ {a}_{i} = \frac{exp ( {e}_{i} / τ )}{{\sum }_{i} exp ( {e}_{i} / τ )} & ( 1 )\end{matrix}$$

Herein, a_(i) is an output of a softmax function associated with an i-th prediction rule 50, and τ represents a temperature.

In addition, a Gumbel-Softmax function, an ST Gumbel-Softmax function being a variant of the Gumbel-Softmax function, and the like may be used. The Gumbel-Softmax function is a function that performs sampling according to a continuous probability distribution, and generates a vector close to a one-hot vector.

The training unit 2100 calculates a prediction loss for the conclusion data 54 acquired by inputting the training input data 82 and the training correct answer data 84, and performs back propagation, based on the calculated prediction loss. Herein, an existing technique can be used as a method of calculating a prediction loss for the conclusion data 54 generated for training and correct answer data prepared for training, and a technique of performing back propagation, based on the prediction loss. Further, various techniques such as a stochastic gradient descent, Momentum, or AdaGrad can be used as a technique of updating a parameter in such a way as to reduce a prediction loss by using back propagation.

### <Generation of Usage Rule Set 60 and Training of Neural Network 30>

There are optimization of the neural network 30 and optimization of a usage rule set 60 as a method of improving accuracy of prediction by the information processing apparatus 2000. The optimization of the neural network 30 is to reduce a prediction loss by training the neural network 30. The optimization of the usage rule set 60 is to appropriately extract the prediction rule 50 effective for prediction from the candidate rule set 70.

Herein, a technique of determining the prediction rule 50 to be included in the usage rule set 60 while conducting training of the neural network 30 (i.e., a technique of simultaneously performing optimization of the neural network 30 and optimization of the usage rule set 60) will be described. First, prior to description of the technique, formulation needed for the description of the technique is performed.

First, a parameter vector representing an occurrence probability of each of the prediction rules 50 included in the candidate rule set 70 is expressed as θ0. θ0 is determined based on a second priority degree given to each of the prediction rules 50 included in the candidate rule set 70. A generation unit 2080 generates the usage rule set 60 by performing sampling for λ times under the occurrence probability represented by the parameter vector θ0. Herein, it is assumed that the prediction rule 50 included in the usage rule set 60 is provided with, as a first priority degree, an occurrence probability in proportion to the number of times the prediction rule 50 is sampled from the candidate rule set 70. The parameter vector θ representing the occurrence probability is formulated as follows.

[Math. 2]

θ=c/λ where c˜Multi(θ₀, λ) (2)

A count c is a vector having a length equal to the number of the prediction rules 50 included in the candidate rule set 70. Each element of c indicates the number of times the associated prediction rule 50 is sampled from the candidate rule set 70. The parameter vector θ is also a vector equal to the number of the prediction rules 50 included in the candidate rule set 70. However, in θ, an occurrence probability of the prediction rule 50 that is not sampled from the candidate rule set 70 (that is, the prediction rule 50 that is not included in the usage rule set 60) is 0. Thus, the vector θ can also be regarded as a vector representing an occurrence probability provided to each of the prediction rules 50 in the usage rule set 60.

When a prediction rule extracted from the usage rule set 60 by the extraction unit 2040 is expressed as z, a phenomenon where z is extracted according to the parameter vector 0 can be formulated as follows. Further, a distribution of probabilities of extracting the prediction rule z can be expressed as P(z|θ).

[Math. 3]

Choose z˜Categorical(θ) (3)

Furthermore, a distribution of probabilities of the neural network 30 extracting the prediction rule z can be expressed as P(z|x,w). x represents the input data 10, and w represents a weight vector of the neural network 30. In terms of the above-described detailed specific example of the neural network 30, P(z|x,w) is a probability distribution represented by a vector acquired by transforming the attention a′ by the softmax layer.

For example, the extraction unit 2040 extracts the prediction rule 50 according to a probability distribution acquired by mixing P(z|x,w) and P(z|θ). The probability distribution acquired by the mixing can be represented as follows.

$$\begin{matrix}[ Math . 4 ] & \\ p ( y \vert x , w , {θ}_{0} , λ ) = {\sum }_{θ} p ( y \vert x , w , θ ) p ( θ \vert {θ}_{0} , λ ) & \\ p ( y \vert x , w , θ ) = {\sum }_{z ∈ R} p ( y \vert z ) p ( z \vert x , w , θ ) & ( 4 ) \\ p ( z \vert x , w , θ ) = \frac{{\sum }_{θ} P ( z \vert x , w ) P ( z \vert θ )}{{\sum }_{{z}^{′} ∈ R} p ( {z}^{′} \vert x , w ) p ( {z}^{′} \vert θ )} & ( 5 )\end{matrix}$$

Herein, a set R represents the candidate rule set 70. Further, x represents input data, and y represents conclusion data.

In such a manner, a method of taking a product of the probability distributions output from two models and normalizing the product again is referred to as Product of Experts (PoE). In PoE that takes a product as compared to Mixture of Experts (MoE) that takes a sum of outputs of models, the prediction rule 50 highly evaluated in both models is selected. Particularly, the prediction rule 50 having the count c of 0 has an appearance probability of 0, and is thus not adopted. Thus, regardless of what kind of a value of a probability based on a neural network, the number of differences of the prediction rule 50 to be used does not exceed 2. This model can be regarded that a small-scale rule set (usage rule set 60) being a partial set is sampled from an original rule set (candidate rule set 70), and the prediction rule 50 is further selected from the sampled rule set.

A technique of simultaneously performing optimization of the usage rule set 60 and optimization of the neural network 30 under the above-described formulation will be described. For example, a generalized EM algorithm that approximates a posteriori probability of the parameter θ by a Metropolis-Hastings algorithm is used for the technique. In other words, θ is sampled from a posteriori distribution p(θ|Y, X, w, θ0, λ), and w is updated based on the sampled θ. Herein, X is a matrix that collects the training input data 82, and an i-th piece of training input data xi is indicated in an i-th row. Further, Y is a matrix that collects the training correct answer data 84, and an i-th piece of training correct answer data yi is indicated in an i-th row.

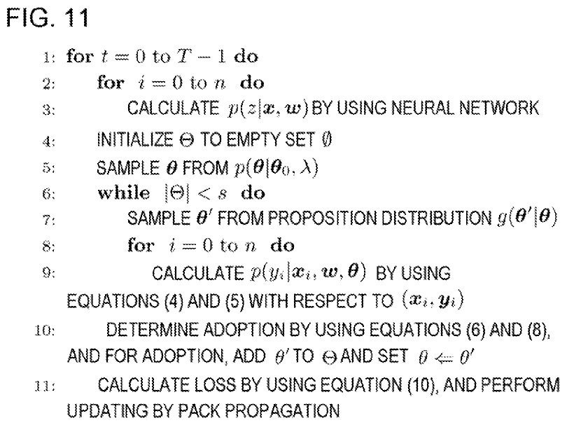

FIG. 11 is a diagram illustrating a technique of simultaneously performing optimization of the usage rule set 60 and optimization of the neural network 30. T is a hyperparameter representing the number of repeated times of a series of processing illustrated in FIG. 11. n represents a total number of pairs of training input data xi and training correct answer data yi. s is a hyperparameter that determines the number of samplings.

In the technique illustrated in FIG. 11, a new θ′ is sampled from a proposition distribution g(θ′|θ) described below, and adoption is determined based on an adoption probability A indicated in the following equation. In other words, adoption is made when a random number in a range of 0 to 1 falls below an adoption probability, and rejection is made in other cases.

$$\begin{matrix}[ Math . 5 ] & \\ A ( {θ}^{′} \vert θ ) = min ( 1 , \frac{p ( {θ}^{′} \vert Y , X , w , {θ}_{0} , λ )}{p ( θ \vert Y , X , w , {θ}_{0} , λ )} \frac{g ( θ \vert {θ}^{′} )}{g ( {θ}^{′} \vert θ )} ) & ( 6 ) \\ = min ( 1 , \frac{p ( {θ}^{′} \vert {θ}_{0} , λ ) p ( Y \vert X , w , {θ}^{′} )}{p ( θ \vert {θ}_{0} , λ ) p ( Y \vert X , w , θ )} \frac{g ( θ \vert {θ}^{′} )}{g ( {θ}^{′} \vert θ )} ) & ( 7 ) \\ p ( Y \vert X , w , θ ) = {\prod }_{( {x}_{i} , {y}_{i} ) ∈ D} p ( {y}_{i} \vert {x}_{i} , w , θ ) & ( 8 )\end{matrix}$$

It is desirable that a distribution in which an adoption probability is increased as much as possible is set as the proposition distribution. Herein, a proposition is achieved as follows. In other words, a total of an appearance number of the count c generated from a multinomial distribution is λ. A count is reduced by one at a uniform probability of 1/λ from the appearance number. Then, θ′=c′/λ is acquired as a count c′ acquired by randomly selecting one prediction rule z at a probability B indicated in the following expression (9) and adding the selected prediction rule z to the count c.

$$\begin{matrix}[ Math . 6 ] & \\ B ∝ p ( z \vert {θ}_{0} ) {\sum }_{{x}_{i} ⊆ X} p ( z \vert {x}_{i} , w ) & ( 9 )\end{matrix}$$

In the proposition distribution, the prediction rule 50 having a great product of an occurrence probability based on a second priority degree given to the prediction rule 50 in advance and an occurrence probability acquired from an output of the neural network 30 is added. Thus, a probability at which the prediction rule 50 is adopted in adoption based on the above-described adoption probability is higher than that when the prediction rule 50 is uniformly randomly selected.

Back propagation is performed with a set of adopted samples as Θ and an expectation value of a negative logarithm likelihood approximated in the following equation (10) as a loss (eleventh line in FIG. 11). In this way, a weight w of a neural network is updated.

$$\begin{matrix}[ Math . 7 ] & \\ - \frac{1}{\vert Θ \vert} {\sum }_{θ ∈ Θ} log L ( w ) = - \frac{1}{\vert Θ \vert} {\sum }_{θ ∈ Θ} log p ( Y \vert X , w , θ ) & ( 10 )\end{matrix}$$

The neural network is optimized by the processing from a first line to an eleventh line in FIG. 11. Subsequently, a point estimation of θ (i.e., the usage rule set 60) is performed by using a maximum posteriori probability estimation (MAP estimation). In other words, the usage rule set 60 is set by adopting the sampled θ having a minimum negative logarithm likelihood among the sampled θ.

### <Example of Hardware Configuration>

A hardware configuration of a computer that achieves the information processing apparatus 2000 according to the example embodiment 3 is illustrated in, for example, FIG. 5 similarly to the example embodiment 1. However, a storage device 1080 of a computer 1000 that achieves the information processing apparatus 2000 according to the present example embodiment further stores a program module that achieves a function of the information processing apparatus 2000 according to the present example embodiment.

While the example embodiments of the present invention have been described with reference to the drawings, the example embodiments are only exemplification of the present invention, and a configuration that combines the configurations in the example embodiments described above and various configurations other than the above-described example embodiments can also be employed.

What is claimed is:

1. An information processing apparatus, comprising:
an acquisition unit that acquires input data; and
an extraction unit that extracts, from a usage rule set including a plurality of prediction rules, a prediction rule associated with the input data by using a neural network, wherein
the prediction rule associates, with each other, condition data indicating a condition being a basis for prediction, and conclusion data representing a prediction based on the condition indicated by the condition data, the information processing apparatus further comprising
an output unit that performs an output based on the extracted prediction rule, wherein
the condition data of the prediction rule associated with the input data indicates a condition satisfied by the acquired input data.

2. The information processing apparatus according to claim 1, wherein
the neural network outputs a degree of appropriateness of being used for prediction related to the input data for each of the prediction rules included in the usage rule set, and
the extraction unit performs extraction of the prediction rule, based on the output degree of appropriateness.

3. The information processing apparatus according to claim 2, wherein
the extraction unit
extracts the prediction rule having the output degree of appropriateness at maximum, or
extracts the prediction rule by sampling the prediction rule from the usage rule set according to a probability distribution based on magnitude of the output degree of appropriateness.

4. The information processing apparatus according to claim 2, wherein
a first priority degree representing a priority degree of being extracted from the usage rule set is given to the prediction rule in the usage rule set, and
the extraction unit calculates a product of the output degree of appropriateness and the first priority degree for each of the prediction rules, and performs extraction of the prediction rule, based on magnitude of a calculated product.

5. The information processing apparatus according to claim 4, wherein
the extraction unit
extracts the prediction rule having the calculated product at maximum, or
extracts the prediction rule by sampling the prediction rule from the usage rule set according to a probability distribution based on magnitude of the calculated product.

6. The information processing apparatus according to claim 1, further comprising
a generation unit that extracts some of the prediction rules from a candidate rule set including a plurality of the prediction rules, and generates the usage rule set including the plurality of extracted prediction rules.

7. The information processing apparatus according to claim 6, wherein
a second priority degree representing a priority degree of being extracted from the candidate rule set is given to the prediction rule in the candidate rule set, and
the generation unit performs sampling processing of sampling a prediction rule having the higher second priority degree at a higher probability from the candidate rule set for a plurality of times, and generates the usage rule set including each of the prediction rules sampled at least once.

8. The information processing apparatus according to claim 7, wherein
a first priority degree representing a priority degree of being extracted from the usage rule set is given to the prediction rule in the usage rule set, and
the generation unit sets the first priority degree of the prediction rule having a greater number of sampling times from the candidate rule set to be a higher value.

9. The information processing apparatus according to claim 1 further comprising
a training unit that updates a parameter of the neural network, wherein
the training unit acquires training input data and training correct answer data,
the neural network outputs a value representing a degree of a probability of being selected as a prediction rule associated with the training input data for each of the prediction rules, and
the training unit calculates a prediction loss by using the value output for each of the prediction rules and the training correct answer data, and updates the parameter of the neural network in such a way as to reduce the prediction loss.

10. A control method executed by a computer, comprising:
an acquisition step of acquiring input data; and
an extraction step of extracting, from a usage rule set including a plurality of prediction rules, a prediction rule associated with the input data by using a neural network, wherein
the prediction rule associates, with each other, condition data indicating a condition being a basis for prediction, and conclusion data representing a prediction based on the condition indicated by the condition data, the control method further comprising
an output step of performing an output based on the extracted prediction rule, wherein
the condition data of the prediction rule associated with the input data indicates a condition satisfied by the acquired input data.

11. The control method according to claim 10, wherein
the neural network outputs a degree of appropriateness of being used for prediction related to the input data for each of the prediction rules included in the usage rule set, and
in the extraction step, extraction of the prediction rule is performed based on the output degree of appropriateness.

12. The control method according to claim 11, wherein
in the extraction step,
the prediction rule having the output degree of appropriateness at maximum is extracted, or
the prediction rule is extracted by sampling the prediction rule from the usage rule set according to a probability distribution based on magnitude of the output degree of appropriateness.

13. The control method according to claim 11, wherein
a first priority degree representing a priority degree of being extracted from the usage rule set is given to the prediction rule in the usage rule set, and
in the extraction step, a product of the output degree of appropriateness and the first priority degree is calculated for each of the prediction rules, and extraction of the prediction rule is performed based on magnitude of a calculated product.

14. The control method according to claim 13, wherein
in the extraction step,
the prediction rule having the calculated product at maximum is extracted, or
the prediction rule is extracted by sampling the prediction rule from the usage rule set according to a probability distribution based on magnitude of the calculated product.

15. The control method according to claim 10, further comprising
a generation step of extracting some of the prediction rules from a candidate rule set including a plurality of the prediction rules, and generating the usage rule set including the plurality of extracted prediction rules.

16. The control method according to claim 15, wherein
a second priority degree representing a priority degree of being extracted from the candidate rule set is given to the prediction rule in the candidate rule set; and
in the generation step, sampling processing of sampling a prediction rule having the higher second priority degree at a higher probability from the candidate rule set is performed for a plurality of times, and the usage rule set including each of the prediction rules sampled at least once is generated.

17. The control method according to claim 16, wherein
a first priority degree representing a priority degree of being extracted from the usage rule set is given to the prediction rule in the usage rule set; and
in the generation step, the first priority degree of the prediction rule having a greater number of sampling times from the candidate rule set is set to be a higher value.

18. The control method according to claim 10, further comprising:
a training step of updating a parameter of the neural network, wherein
in the training step, training input data and training correct answer data are acquired,
the neural network outputs a value representing a degree of a probability of being selected as a prediction rule associated with the training input data for each of the prediction rules, and
in the training step, a prediction loss is calculated by using the value output for each of the prediction rules and the training correct answer data, and the parameter of the neural network is updated in such a way as to reduce the prediction loss.

19. A non-transitory computer readable medium storing a program causing a computer to execute each step of a control method, the method comprising:
an acquisition step of acquiring input data; and
an extraction step of extracting, from a usage rule set including a plurality of prediction rules, a prediction rule associated with the input data by using a neural network, wherein
the prediction rule associates, with each other, condition data indicating a condition being a basis for prediction, and conclusion data representing a prediction based on the condition indicated by the condition data, the control method further comprising
an output step of performing an output based on the extracted prediction rule, wherein
the condition data of the prediction rule associated with the input data indicates a condition satisfied by the acquired input data.
